(19) United States
(12) Patent Application Publication
(10) Pub. No.: US 2026/0307100 A1
(43) Pub. Date: Oct. 8, 2026

(54) DEVICE FOR THE DISPENSING OF A POWDERED PRODUCT ON A CERAMIC MANUFACTURED ARTICLE

(71) Applicant: SYSTEM CERAMICS S.P.A., Fiorano Modenese (MO) (IT)

(72) Inventors: Luciano BASTARDI, Fiorano Modenese (MO) (IT); Marco VALENTINI, Fiorano Modenese (MO) (IT)

(21) Appl. No.: 19/482,414

(22) PCT Filed: May 7, 2024
(86) PCT No.: PCT/IB2024/054417

§ 371 Date: Nov. 7, 2025

(30) Foreign Application Priority Data
May 8, 2023 (IT) 102023000009117

(51) Int. Cl. B05C 19/00; B05C 19/04

(52) U.S. Cl. CPC B05C 19/008; B05C 19/04

(57) ABSTRACT

Device (1) for dispensing a powder (P) on a ceramic article (M) comprising: a hopper (3) for a powder to be released on the ceramic article to be decorated; a plurality of nozzles (4), each defining a relevant containment chamber (5) for containing powder, communicating with the hopper (3) and provided with a relevant output gap (6); releasing means (12) controllable to selectively dispense the powder through the relevant output gaps (6) of the nozzles (4); distribution means (14) of the powder on the ceramic article to be decorated, comprising a rotatable roller (15) arranged below the output gaps (6) and at least one supporting element (19) of the roller (15), adapted to interact with the roller itself along its longitudinal development. Preferably, the supporting element (19) is of the contactless type, in particular of the magnetic type, comprising first magnetic means (20) adapted to define a first magnetic field (20a) and the roller (15) comprises second magnetic means (21) adapted to define a second magnetic field (21a), wherein the polarities of the magnetic means (20, 21) are arranged in such a manner that the magnetic fields (20a, 21a) repel each other to counteract the axial inflection of the roller (15).

### TECHNICAL FIELD

The present invention relates to a device for the dispensing of a powdered product on a ceramic manufactured article.

### BACKGROUND ART

In the field of ceramics, the use of a process for obtaining textured surfaces has long been known, i.e., characterized by reliefs and/or depressions so as to obtain a three-dimensional effect, which involves the application of an adhesive substance in liquid form on the manufactured article to be decorated according to a predefined design, the subsequent dispensing of a powdered product on top of the adhesive substance so that it is made to adhere to the manufactured article itself, the suction of the excess product that has not adhered to the adhesive substance and, finally, the firing of the manufactured article thus decorated so that the powdered product is melted and a decorative layer in relief is obtained.

More specifically, as a result of the firing of the ceramic manufactured article, the powdered product joins the ceramic manufactured article to form a single body piece having a three-dimensional decoration on its exposed surface.

The phase of dispensing of the powdered product can be carried out in different ways, namely by releasing the product on the entire exposed surface of the ceramic manufactured article or only at the areas affected by the previously applied adhesive substance in order to reduce material waste.

Some devices for the dispensing of the powdered product of known type comprise: a hopper adapted to contain the powdered product, a plurality of nozzles arranged inferiorly to the hopper and provided with relevant chambers adapted to receive the powdered product from the hopper and control means for controlling the opening of the nozzles themselves.

In other words, the control means are adapted to control the opening time of the nozzles and, consequently, the amount of powdered product dispensed onto the ceramic manufactured article transiting below them.

Since the output gaps of the powdered product with which the nozzles are provided have fixed and predefined dimensions, it follows that the amount of product released on the unit area of the ceramic manufactured article, the rate of forward movement of the same being equal, is substantially constant.

This limits the graphic effects that can be achieved on the ceramic manufactured article, since the thickness of the relief obtained as a result of the released powdered product turns out to be almost constant in the various areas of the manufactured article.

Another drawback of the devices for the dispensing of a powdered product of known type consists in the fact that they result in wasted material, as it may happen that the amount of powdered product released on the manufactured article is excessive and, therefore, only part of it adheres onto the underlying adhesive substance, the remaining part being removed later.

Some equipment for the decoration of ceramic manufactured articles is known from WO 2020/224348 A1 and IT 2020 000 9067 A1.

### DESCRIPTION OF THE INVENTION

The main aim of the present invention is to devise a device for the dispensing of a powdered product on a ceramic manufactured article that allows the drawbacks of the prior art to be overcome and to adjust the amount of the product released on the unit area of the ceramic manufactured articles the rate of forward movement of the manufactured articles being equal.

Within this aim, one object of the present invention is to allow the thickness of the relief obtained on the ceramic manufactured article to be varied as a result of the release of the powdered product thereon.

Yet another object is to devise a device for the dispensing of a powdered product on a ceramic manufactured article which allows minimizing the waste of the product itself.

Another object of the present invention is to devise a device for the dispensing of a powdered product on a ceramic manufactured article which allows the aforementioned drawbacks of the prior art to be overcome within the framework of a simple, rational, easy and efficient to use as well as cost-effective solution.

A device for the dispensing of a powdered product on a ceramic manufactured article comprises: a load-bearing frame, a hopper associated with the frame for the containment of a powdered product to be released onto a manufactured article to be decorated, a plurality of nozzles associated with the frame and each defining a relevant containment chamber for containing the powdered product communicating with the hopper and provided with a relevant output gap, product releasing means associated with a plurality of nozzles and selectively controllable to allow dispensing the product through the relevant output gaps, distribution means for distributing the product dispensed through the output gaps onto the manufactured article to be decorated, wherein the distribution means comprise at least one roller element arranged below the output gaps and operable in rotation around a relevant axis, and at least one supporting element of the roller element adapted to interact with the roller element itself along its longitudinal development.

Preferably, the supporting element is of the contactless type.

Preferably, the supporting element is of the magnetic type and comprises first magnetic means adapted to define a first magnetic field and the roller element comprises second magnetic means adapted to define a second magnetic field, where the polarities of the magnetic means are arranged so that the magnetic fields repel each other to offset for the axial deflection of the roller element.

Preferably, the supporting element is arranged below the roller element and is movable parallel to its axis of rotation so as to change the intensity of the first magnetic field where the second magnetic field is located.

Preferably, the nozzles are aligned with each other along a direction of decoration and the roller element extends parallel to the direction of decoration and is arranged facing each of the output ports.

Preferably, adjustment means are provided for adjusting the rotational speed of the roller element.

Preferably, movement means are provided for moving the manufactured article to be decorated along a direction of forward movement, which are arranged below the nozzles, the direction of decoration being arranged transversely to the direction of forward movement, and the roller element rotates so that the portion of its lateral surface facing the output ports moves in a concordant way with the direction of forward movement.

Preferably, sensor means are provided adapted to detect the position of the manufactured article to be decorated along the direction of forward movement with respect to the nozzles, at least one command and control unit operationally connected to the adjustment means, to the sensor means and to the movement means, wherein the command and control unit is configured to control the rotational speed of the roller element around the relevant axis depending on the position of the manufactured article with respect to the nozzles and on its speed of forward movement to vary the amount of product dispensed per unit area.

Preferably, distribution means are provided for distributing the product contained in the hopper within the containment chambers.

Preferably, the distribution means comprise at least two augers overlapping each other, operable in rotation around a relevant axis and placed between the hopper and the nozzles, and wherein, depending on the mutual way of rotation of the augers, the helixes of the portions vertically aligned with each other of the augers are oriented with respect to each other so as to drag the product along opposite directions.

Preferably, said augers rotate in a mutually opposite way and the portions vertically aligned of the augers have helixes having the same way.

Preferably, the augers comprise at least one lower auger and one upper auger, wherein the lower auger has at least a first portion and a second portion that are adjacent to each other and the helixes of which have a mutually opposite way, and wherein the upper auger has at least a third portion and a fourth portion that are adjacent to each other and overlapping to the first portion and to the second portion respectively, wherein the helix of the third portion has the same way as the helix of the first portion and the helix of the fourth portion has the same way as the helix of the second portion, the lower auger rotating in the opposite way to the upper auger.

Preferably, the augers rotate in a concordant way with each other and the portions vertically aligned with each other of the augers have helixes with opposite way.

Preferably, the augers comprise at least one lower auger and one upper auger, wherein the lower auger has at least a first portion and a second portion that are adjacent to each other and the helixes of which have a mutually opposite way and wherein the upper auger has at least a third portion and a fourth portion that are adjacent to each other and overlap to the first portion and to the second portion respectively, wherein the helix of the third portion has an opposite way to the helix of the first portion and the helix of the fourth portion has an opposite way to the helix of the second portion, the lower auger rotating in concordant way with the upper auger.

Preferably, the hopper has an unloading port arranged at the median area of the augers, wherein the first portion and the second portion are adapted to drag the product from the median area towards the ending areas of the lower auger, thus distributing the product within the chambers, and wherein the third portion and the fourth portion are adapted to re-circulate the product from the ending areas of the upper auger towards the median area.

A piece of equipment for the decoration of ceramic manufactured articles, comprises: movement means of a ceramic manufactured article to be decorated along a direction of forward movement, application means for applying an adhesive substance in liquid form on the manufactured article, at least one device for the dispensing of a powdered product on the manufactured article provided with distribution means for distributing the powdered product on the manufactured article to be decorated, comprising at least one roller element arranged below the output gaps of the powdered product and operable in rotation around a relevant axis, and provided with at least one supporting element of the roller element adapted to interact with the roller element itself along its longitudinal development, wherein the device is arranged downstream of the application means along the direction of forward movement, suction means for sucking in the excess product from the manufactured article which are arranged downstream of the device along the direction of forward movement.

### BRIEF DESCRIPTION OF THE DRAWINGS

Other characteristics and advantages of the present invention will become more apparent from the description of a preferred, but not exclusive, embodiment of a device for the dispensing of a powdered product on a ceramic manufactured article, illustrated by way of an indicative, yet non-limiting example, in the attached tables of drawings in which:

FIG. 1 is an axonometric view of a device according to the invention;

FIG. 2 is an axonometric view of a portion of the device in FIG. 1;

FIG. 2A is an enlarged view of a portion of the device in FIG. 2;

FIG. 3 is a front elevation view of the device in FIG. 2;

FIG. 4 is a cross-sectional view of the device in FIG. 3 along the IV-IV track plane.

FIG. 5 is a schematic representation of the supporting means of the roller element of a device according to the invention;

FIG. 6 is a schematic representation of a piece of equipment for the decoration of ceramic manufactured articles according to the invention.

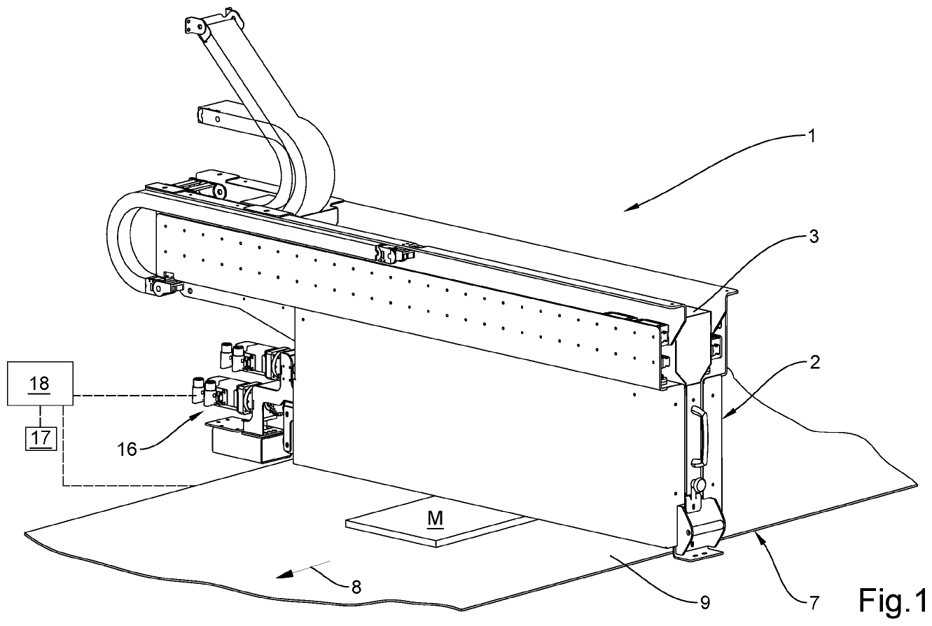

### EMBODIMENTS OF THE INVENTION

With particular reference to these figures, reference numeral 1 globally denotes a device for the dispensing of a powdered or granular product P on a ceramic manufactured article M.

The device 1 comprises a load-bearing frame 2, a hopper 3 associated with the frame 2 for the containment of a powdered product P to be released on the manufactured article M to be decorated, a plurality of nozzles 4 associated with the frame 2 and each defining a relevant containment chamber 5 for containing the product P communicating with the hopper 3 and provided with a relevant output gap 6.

It should be noted that the product P can be of various grain sizes, e.g. of the type of fine powder, granules, grits, flakes or any other material in granular or substantially granular form suitable for making a relief decoration on the surface of a ceramic manufactured article M.

The frame 2 of the device 1 can be positioned, directly or indirectly, to rest on the ground. In particular, the frame 2 can provide extensions (not shown in the figures) for direct support on the ground, or it can be connected to the framework of a piece of equipment into which the device 1 is fitted, e.g. of the piece of equipment 10 described in detail later in this description.

Appropriately, movement means 7 of the manufactured article M are provided along a direction of forward movement 8. The movement means 7 define a supporting plane 9 of the manufactured articles M arranged inferiorly to the nozzles 4 and consist, e.g., of a motorized conveyor belt or of a plurality of motorized belts. The output gaps 6 of the nozzles 4 are then arranged facing the supporting plane 9.

The movement means 7 can be part of the device 1 or of the equipment described below and encompassing the device 1.

In more detail, the nozzles 4 are substantially aligned with each other along a direction of decoration 11 which is transverse to the direction of forward movement 8 of the manufactured articles M. The nozzles 4 are arranged along the direction of decoration 11 so as to cover the entire extension of the supporting plane 9 along the same direction.

The device 1 then comprises releasing means 12 for releasing the product P associated with a plurality of nozzles 4, preferably at each of them, and selectively controllable to enable the dispensing of the product P through the relevant output gaps 6.

Preferably, the releasing means 12 are of the pneumatic type and comprise a pneumatic circuit 13 communicating with the chambers 5 of the relevant nozzles 4 and by means of which the vacuum is maintained within the chambers themselves, so as to retain the product contained therein. The pneumatic circuit 13 is provided with valve means (not visible in the figures) which are operable to introduce pressurized air into the chambers 5 so as to cause the outflow of the product P. As can be easily understood by the technician in the field, the time of opening of the valve means, during which pressurized air is therefore introduced into the chambers 5, affects the amount of product P dispensed through the relevant nozzles 4.

Advantageously, the releasing means 12 of the product P associated with each nozzle 4 are operable independently of each other, so that dispensing through each nozzle 4 can be selectively controlled.

Different embodiments of the releasing means 12 which are known to the industry technician cannot be ruled out.

The device 1 comprises distribution means 14 of the product P dispensed through the output gaps 6 on the manufactured article M to be decorated. In other words, the distribution means 14 are adapted to adjust the amount of product P applied on the unit area of the manufactured article M transiting below the nozzles 4.

According to the invention, the distribution means 14 comprise at least one roller element 15 arranged below the output gaps 6 and operable in rotation around a relevant axis X. Specifically, the axis X of rotation of the roller element 15 coincides with the geometric axis thereof.

Appropriately, the roller element 15 is made to rotate so as to drag the product P coming out of the output gaps 6 in a concordant way with the direction of forward movement 8. In other words, the portion of the lateral surface of the roller element 15 facing the output gaps 6 rotates in a concordant way with the direction of forward movement 8.

In more detail, the roller element 15 extends parallel to the direction of decoration 11 and is arranged facing each of the output gaps 6. In other words, the roller element 15 develops along the entire extension of the nozzles 4 along the direction of decoration 11.

Advantageously, the device 1 comprises adjustment means 16 for adjusting the rotational speed of the roller element 15. In fact, by adjusting the rotational speed of the roller element 15, it is possible to adjust the amount of product P released on the unit area of the manufactured article M. In fact, the higher the rotational speed of the roller element 15, the greater the amount of product P released on the manufactured article M, per unit area, and vice versa. The adjustment means 16 are, e.g., of the type of motor means.

Conveniently, the device 1 also comprises sensor means 17 adapted to detect the position of the manufactured article M to be decorated along the direction of forward movement 8 with respect to the nozzles 4 and at least one command and control unit 18, of the type of an electronic control unit, operationally connected to the adjustment means 16, to the sensor means 17 and to the movement means 7. Specifically, the command and control unit 18 is configured to control the rotational speed of the roller element 15 around the relevant axis depending on the position of the manufactured article M with respect to the nozzles 4 and on its speed of forward movement so as to apply the desired amount of the product P per unit area to the manufactured article M.

According to the invention, the device 1 comprises at least one supporting element 19 of the roller element 15 which is adapted to interact with the roller element itself along its longitudinal development. In fact, the roller element 15 is generally supported where its axial ends are located and, particularly in the case of high longitudinal extensions, it may bend at its median area, thus causing uneven distribution of the product P on the underlying manufactured articles M. The supporting element 19 is therefore adapted to interact with the roller element 15 in order to keep its axis substantially straight.

Advantageously, the supporting element 19 is of the contactless type. This avoids the interaction of the supporting element 19 with the surface of the roller element 15 and, consequently, phenomena of degradation or wear of the same, which could affect the proper distribution of the product P.

In more detail, the supporting element 19 is of the magnetic type and comprises first magnetic means 20 which are adapted to define a first magnetic field 20a and the roller element 15 comprises second magnetic means 21 which are adapted to define a second magnetic field 21a, wherein the polarities of the first magnetic means 20 and of the second magnetic means 21 are arranged in such a manner that the relevant magnetic fields 20a, 21a repel each other to offset for the axial inflection of the roller element 15.

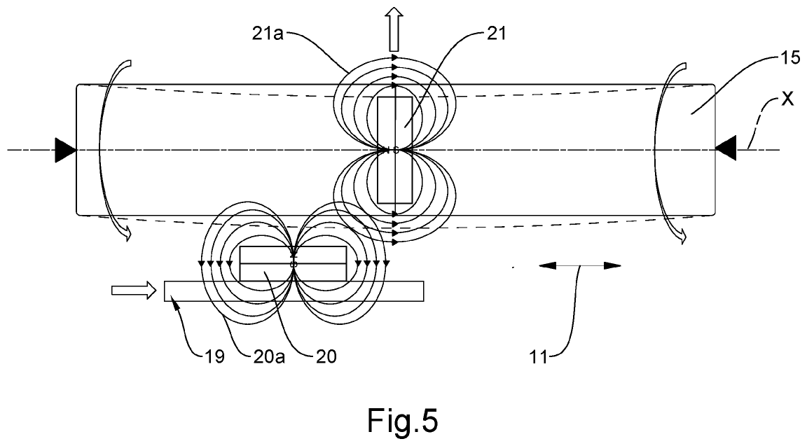

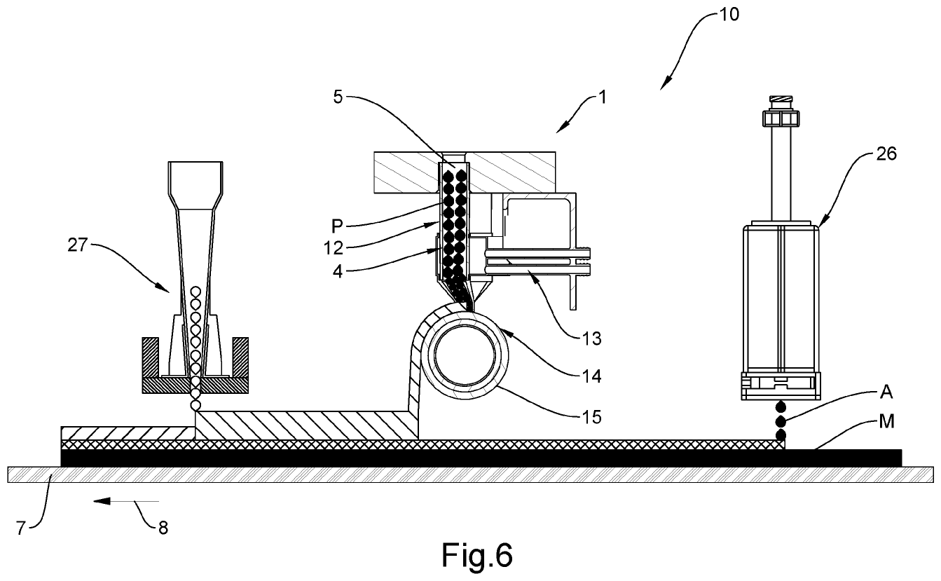

The magnetic fields 20a and 21a generated by the magnetic means 20 and 21 are schematically shown in FIG. 5.

In other words, as a result of the repulsion of the magnetic fields 20a and 21a, the roller element 15 is pushed upwards away from the supporting element 19.

Preferably, the supporting element 19 is arranged below the roller element 15 and is movable parallel to the axis X of rotation so as to change the intensity of the first magnetic field 20a where the second magnetic field 21a is located. Therefore, by moving the supporting element 19 parallel to the axis X, it is possible to change the intensity of the first magnetic field 20a “sensed” by the second magnetic field 21a and, therefore, the amount of the displacement of the roller element itself away from the supporting element 19.

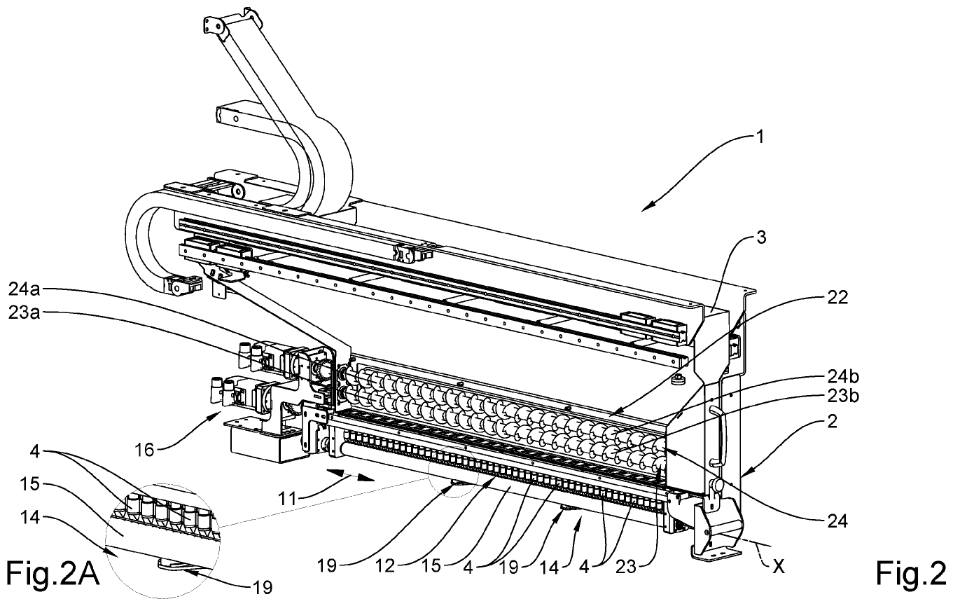

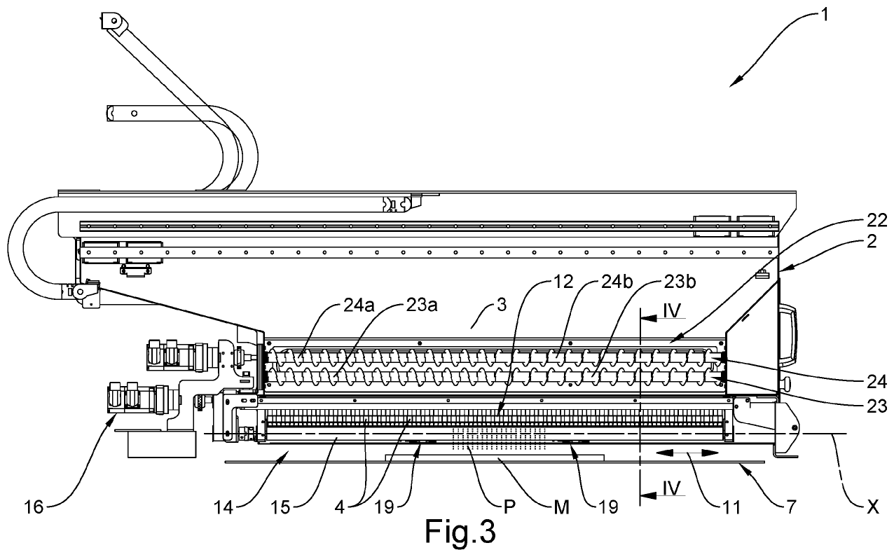

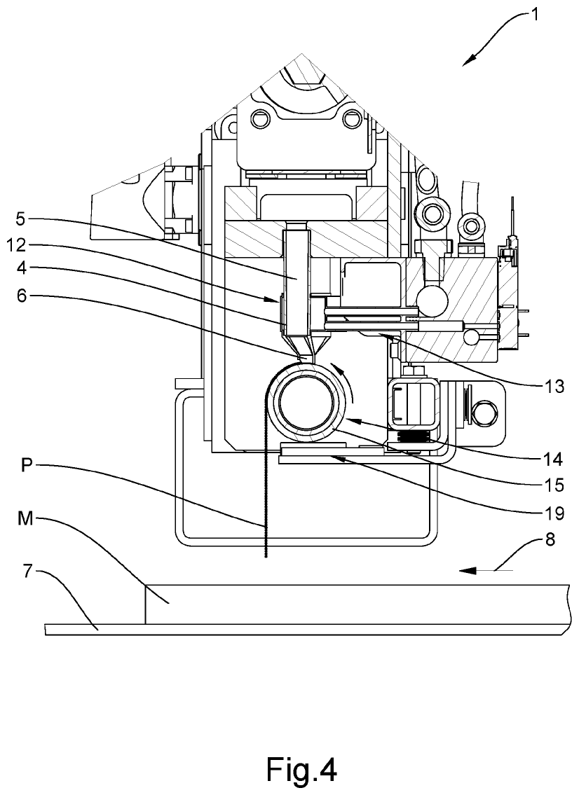

In the embodiment shown in FIGS. 2 and 3, the device 1 comprises a plurality of supporting elements 19, two in this case, which are movable independently of each other in a direction parallel to the axis X to optimize the interaction of the relevant first magnetic fields 20a with the second magnetic field 21a.

Advantageously, the device 1 comprises distribution means 22 of the product P contained in the hopper 3 within the chambers 5 of the nozzles 4.

More particularly, the distribution means 22 comprise at least two augers 23 and 24 overlapping each other, operable in rotation around a relevant axis and placed between the hopper 3 and the nozzles 4, wherein, depending on the way of mutual rotation of the augers 23 and 24, the helixes of the portions 23a, 23b, 24a, 24b vertically aligned of the two augers 23, 24 are oriented so as to drag the product P along opposite directions.

In the preferred embodiment shown in FIGS. 2 and 3, the augers 23 and 24 rotate in a mutually opposite way and the portions 23a, 23b, 24a, 24b vertically aligned of the augers 23 and 24 have helixes with the same way.

More particularly, in this embodiment, the augers 23, 24 comprise at least one lower auger 23 and one upper auger 24 rotating in a mutually opposite way (i.e., if the lower auger 23 rotates clockwise, the upper auger 24 rotates counterclockwise and vice versa). The lower auger 23 has at least a first portion 23a and a second portion 23b which are adjacent to each other and the helixes of which have a mutually opposite way, and the upper auger 24 has at least a third portion 24a and a fourth portion 24b adjacent to each other and the helixes of which have a mutually opposite way. The third portion 24a overlaps vertically onto the first portion 23a and the relevant helixes have the same way of inclination, and similarly, the fourth portion 24b overlaps vertically onto the second portion 23b and their helixes have the same way of inclination.

In an alternative embodiment not shown in the figures, the augers 23 and 24 rotate in a mutually concordant way and portions 23a, 23b, 24a, 24b vertically aligned of the augers 23 and 24 have helixes with mutually opposite way.

More particularly, in this alternative embodiment, the augers 23, 24 comprise at least one lower auger 23 and one upper auger 24 rotating in concordant way with each other (i.e., if the lower auger 23 rotates clockwise, the upper auger 24 also rotates clockwise and vice versa). The lower auger 23 has at least a first portion 23a and a second portion 23b which are adjacent to each other and the helixes of which have a mutually opposite way, and the upper auger 24 has at least a third portion 24a and a fourth portion 24b adjacent to each other and the helixes of which have opposite way. The third portion 24a overlaps vertically onto the first portion 23a and the relevant helixes have opposite way, and similarly, the fourth portion 24b overlaps vertically onto the second portion 23b and their helixes have a mutually opposite way.

Appropriately, the hopper 3 has an unloading port arranged at the median area of the augers 23, 24, so as to unload the product P centrally with respect to the lower auger 23 and to the upper auger 24, i.e., at the junction area of the relevant portions 23a, 23b and 24a, 24b. The first portion 23a and the second portion 23b are adapted to drag the product P from the median area towards the ending areas of the lower auger 23, so as to distribute the product P within the chambers 5, while the third portion 24a and the fourth portion 24b are adapted to re-circulate the product P from the ending areas of the upper auger 24 towards the median area.

In other words, the product P that is released from the hopper 3 where the central area of the augers 23, 24 is located and is dragged outwards by the lower auger 23, meanwhile falling within the chambers 5 below and, once it reaches its axial ends, is brought back towards the central area by the upper auger 24.

This invention also relates to a piece of equipment 10 for the decoration of ceramic manufactured articles M comprising, in addition to the aforementioned movement means 7, application means 26 for applying an adhesive substance A in liquid form on the manufactured article M, at least one device 1 as described above and arranged downstream of the application means 26 along the direction of forward movement 8 and suction means 27 for sucking in the excess product P from the manufactured article M arranged downstream of the device 1 along the direction of forward movement 8.

Specifically, the application means 26 are of the type of a digital printer adapted to dispense the adhesive substance A according to a predefined design on the manufactured article M. The adhesive substance A is preferably of the low-viscosity type and adapted to cure when subjected to radiation of a predefined frequency.

The piece of equipment 10 may also comprise, downstream of the suction means 27, additional decoration means (not shown in detail in the figures) adapted to apply a decorative ink on the manufactured article M according to a design coordinated with the predefined design mentioned above.

Preferably, the piece of equipment 10 also comprises decoration means for decorating the manufactured article M, not shown in detail in the figures and of a type known to the technician in the field (such as e.g. a digital printing unit) arranged upstream of the application means 26 with respect to the direction of forward movement 8. The decoration means are thus adapted to apply a decorative substance, such as e.g. ink or glaze, on the manufactured article M according to a predefined design.

Preferably, the application means 26 are adapted to dispense the adhesive substance A in a coordinated manner to the predefined design made on the manufactured article M by the aforementioned decoration means.

The operation of the piece of equipment according to the invention is as follows.

At least one ceramic manufactured article M is first provided for decoration and an adhesive substance A in liquid form is applied thereto.

Preferably, the application of the adhesive substance A is carried out according to a predefined design.

More particularly, the adhesive substance A is applied by means of the application means 26.

Next, a powdered product P is dispensed on the manufactured article M.

According to the invention, such dispensing is carried out by adjusting the amount of product P released on the unit area of the manufactured article M.

Advantageously, the phase of dispensing is carried out in such a way as to release the product P selectively where the adhesive substance A applied according to the predefined design is located. This minimizes material waste.

Appropriately, the dispensing of the product P is carried out by means of the device 1.

Following the phase of dispensing, suction is carried out on the product P that may not have adhered to the adhesive substance A or has been deposited outside the predefined design.

It has in practice been ascertained that the described invention achieves the intended objects, and in particular, the fact is emphasized that the device covered by the present invention makes it possible to distribute the powdered product on the manufactured article to be decorated, i.e., to adjust the amount that is applied on the surface unit, depending on the specific needs of the case.

In particular, by appropriately adjusting the rotational speed of the roller element, it is possible to vary the amount of the product applied on the manufactured article.

This allows for a greater variety of aesthetic effects on the finished product and minimizes the amount of wasted material.

Again, by adjusting the position of the supporting elements, it is possible to offset for the bending of the roller element at its central area so that its longitudinal axis is as straight as possible and thus avoid uneven distribution of the product.

Last but not least, the described distribution means, provided with a pair of overlapping augers, enable optimization of product distribution within the nozzle chambers.

1) Device (1) for the dispensing of a powdered product (P) on a ceramic manufactured article (M) comprising:
a load-bearing frame (2);
a hopper (3) associated with said frame (2) for the containment of a powdered product (P) to be released on a manufactured article (M) to be decorated;
a plurality of nozzles (4) associated with said frame (2) and each defining a relevant containment chamber (5) for containing the powdered product (P) communicating with said hopper (3) and provided with a relevant output gap (6);
releasing means (12) for releasing the product (P) associated with a plurality of said nozzles (4) and selectively controllable to enable the dispensing of the product (P) through the relevant output gaps (6);
distribution means (14) of the product (P) dispensed through said output gaps (6) on the manufactured article (M) to be decorated;
characterized by the fact that said distribution means (14) comprise at least one roller element (15) arranged below said output gaps (6) and operable in rotation around a relevant axis (X) and by the fact that it comprises at least one supporting element (19) of said roller element (15) which is adapted to interact with the roller element itself along its longitudinal development.

2) Device (1) according to claim 1, characterized by the fact that said supporting element (19) is of the contactless type.

3) Device (1) according to claim 2, characterized by the fact that said supporting element (19) is of the magnetic type and comprises first magnetic means (20) adapted to define a first magnetic field (20a) and by the fact that said roller element (15) comprises second magnetic means (21) adapted to define a second magnetic field (21a), wherein the polarities of said magnetic means (20, 21) are arranged in such a manner that said magnetic fields (20a, 21a) repel each other to offset for the axial inflection of said roller element (15).

4) Device (1) according to claim 3, characterized by the fact that said supporting element (19) is arranged below said roller element (15) and is movable parallel to said axis (X) of rotation so as to change the intensity of said first magnetic field (20a) where said second magnetic field (21a) is located.

5) Device (1) according to claim 1, characterized by the fact that said nozzles (4) are aligned with each other along a direction of decoration (11) and by the fact that said roller element (15) extends parallel to said direction of decoration (11) and is arranged facing each of said output gaps (6).

6) Device (1) according to claim 1, characterized by the fact that it comprises adjustment means (16) for adjusting the rotational speed of said roller element (15).

7) Device (1) according to claim 1, characterized by the fact that it comprises movement means (7) of the manufactured article (M) to be decorated along a direction of forward movement (8), arranged below said nozzles (4), said direction of decoration (11) being arranged transversely with respect to said direction of forward movement (8), and by the fact that said roller element (15) rotates in such a manner that the portion of its lateral surface facing said output gaps (6) moves in a concordant way with said direction of forward movement (8).

8) Device (1) according to claim 6, characterized by the fact that it comprises sensor means (17) adapted to detect the position of the manufactured article (M) to be decorated along said direction of forward movement (8) with respect to said nozzles (4), at least one command and control unit (18) operationally connected to said adjustment means (16), to said sensor means (17) and to said movement means (7), wherein said command and control unit (18) is configured to control the rotational speed of said roller element (15) around the relevant axis depending on the position of the manufactured article (M) with respect to said nozzles (4) and on its speed of forward movement to vary the amount of product (P) dispensed per unit area.

9) Device (1) according to claim 1, characterized by the fact that it comprises distribution means (22) for distributing the product (P) contained in said hopper (3) inside said containment chambers (5).

10) Device (1) according to claim 9, characterized by the fact that said distribution means (22) comprise at least two augers (23, 24) overlapping each other, operable in rotation around a relevant axis and placed between said hopper (3) and said nozzles (4) wherein, depending on the way of rotation of said augers (23, 24), the helixes of the portions (23a, 23b, 24a, 24b) vertically aligned of said augers (23, 24) are oriented to each other so as to drag the product (P) along opposite directions.

11) Device (1) according to claim 10, characterized by the fact that said augers (23, 24) rotate in a mutually opposite way and by the fact that the portions (23a, 23b, 24a, 24b) vertically aligned with each other of said augers (23, 24) have helixes with the same way.

12) Device (1) according to claim 11, characterized by the fact that said augers (23, 24) comprise at least one lower auger (23) and one upper auger (24), wherein said lower auger (23) has at least a first portion (23a) and a second portion (23b) adjacent to each other and the helixes of which have a mutually opposite way and wherein said upper auger (24) has at least a third portion (24a) and a fourth portion (24b) adjacent to each other and overlapping to said first portion (23a) and to said second portion (23b) respectively, wherein the helix of said third portion (24a) has the same way as the helix of said first portion (23a) and the helix of said fourth portion (24b) has the same way as the helix of said second portion (23b), said lower auger (23) rotating in the opposite way to said upper auger (24).

13) Device (1) according to claim 10, characterized by the fact that said augers (23, 24) rotate in a concordant way with each other and by the fact that the portions (23a, 23b, 24a, 24b) vertically aligned with each other of said augers (23, 24) have helixes with an opposite way.

14) Device (1) according to claim 13, characterized by the fact that said augers (23, 24) comprise at least one lower auger (23) and one upper auger (24), wherein said lower auger (23) has at least a first portion (23a) and a second portion (23b) adjacent to each other and the helixes of which have a mutually opposite way and wherein said upper auger (24) has at least a third portion (24a) and a fourth portion (24b) adjacent to each other and overlapping to said first portion (23a) and to said second portion (23b) respectively, wherein the helix of said third portion (24a) has an opposite way to the helix of said first portion (23a) and the helix of said fourth portion (24b) has an opposite way to the helix of said second portion (23b), said lower auger (23) rotating in a concordant way with said upper auger (24).

15) Device (1) according to claim 12, characterized by the fact that said hopper has an unloading port arranged at the median area of said augers (23, 24), by the fact that said first portion (23a) and said second portion (23b) are adapted to drag the product (P) from said median area towards the ending areas of said lower auger (23), thus distributing the product (P) within said chambers (5), and by the fact that said third portion (24a) and said fourth portion (24b) are adapted to re-circulate the product (P) from the ending areas of said upper auger

(24) towards said median area.

16) Equipment (10) for the decoration of ceramic manufactured articles, characterized by the fact that it comprises:
movement means (7) of a ceramic manufactured article (M) to be decorated along a direction of forward movement (8);
application means (26) for applying an adhesive substance (A) in liquid form on the manufactured article (M);
at least one device (1) for the dispensing of a powdered product (P) on the manufactured article (M) according to claim 1, wherein said device is arranged downstream of said application means (26) along said direction of forward movement (8);
suction means (27) for sucking in the excess product (P) from said manufactured article (M) which are arranged downstream of said device (1) along said direction of forward movement (8).
